(19) United States
(12) Patent Application Publication
(10) Pub. No.: US 2020/0159756 A1
(43) Pub. Date: May 21, 2020

(54) ELECTRONIC DOCUMENT BASED CONTENT TOOLS

(71) Applicant: LIVING TREE SOFTWARE, LLC, Highland, UT (US)

(72) Inventor: Oak Duke Norton, III, Highland, UT (US)

(21) Appl. No.: 16/688,566

(22) Filed: Nov. 19, 2019

Related U.S. Application Data
(63) Continuation of application No. 62/769,344, filed on Nov. 19, 2018.

(51) Int. Cl. G06F 16/34; G06F 16/35; G06F 3/0482; G06F 3/0483; G06F 17/24; G06F 17/21

(52) U.S. Cl. CPC G06F 16/345; G06F 16/355; G06F 17/211; G06F 3/0483; G06F 17/241; G06F 3/0482

(57) ABSTRACT

A method may include receiving, at a user interface, a search query of electronic document based content. The method may also include displaying, in a search result window of the user interface, one or more search results based on the search query, each search result of the one or more search results including: (i) a respective excerpt of the electronic document based content and (ii) a corresponding text box displayed in the search result window adjacent to each search result of the one or more search results. The method may further include receiving, at the search result window, text input within a text box corresponding to one of the one or more search results. The method may also include displaying, within the search result window, the text input saved within the text box. The method may further include combining search results based on two or more search queries.

### CROSS-REFERENCE TO RELATED APPLICATIONS

This application claims the benefit of U.S. patent application Ser. No. 62/769,344, filed on Nov. 19, 2018; the disclosure of which is incorporated herein by reference in its entirety.

### FIELD

The application relates generally to electronic document based content tools.

### BACKGROUND

Electronic documents may include any digital version of a document. Electronic documents may help improve accessibility to a wide variety of different types of electronic documents, including books, pamphlets, reports, forms, articles, applications, etc. For example, electronic documents may be accessible via client devices like desktop computers, tablets, cell phones, watches, smart devices, appliances, and other suitable client devices. As demand for accessibility to electronic documents grows, aspects of user interaction with electronic documents, e.g., via user interfaces of client devices, may continue to improve.

The subject matter claimed herein is not limited to embodiments that solve any disadvantages or that operate only in environments such as those described above. Rather, this background is only provided to illustrate one example technology area where some embodiments described herein may be practiced.

### SUMMARY

A method may include receiving, at a user interface, a search query of electronic document based content. The method may also include displaying, in a search result window of the user interface, one or more search results based on the search query, each search result of the one or more search results including: (i) a respective excerpt of the electronic document based content and (ii) a corresponding text box displayed in the search result window adjacent to each search result of the one or more search results. The method may further include receiving, at the search result window, text input within a text box corresponding to one of the one or more search results. The method may also include displaying, within the search result window, the text input saved within the text box.

### BRIEF DESCRIPTION OF THE DRAWINGS

Example embodiments will be described and explained with additional specificity and detail through the use of the accompanying drawings in which:

FIG. 1 is a first example embodiment of a user interface;

FIG. 2 is a second example embodiment of a user interface;

FIG. 3 is a third example embodiment of a user interface;

FIG. 4 is a fourth example embodiment of a user interface;

FIG. 5 is a fifth example embodiment of a user interface;

FIG. 6 is a first example embodiment of modifying text of an excerpt of a search result;

FIG. 7 is a second example embodiment of modifying text of an excerpt of a search result;

FIG. 8 is a sixth example embodiment of a user interface;

FIG. 9 is an example embodiment of a collection note;

FIG. 10 is an example embodiment of an advanced search; and

FIG. 11 is an example method of performing a search.

### DESCRIPTION OF EMBODIMENTS

An electronic document may be viewed in a user interface designed to display content of the electronic document. The user interface may also include tools to allow the user to interact with the electronic document via user inputs. As referred to in the present disclosure, the term “tools” may include any aspect of a user interface that can help a user to interact with the content of the electronic document. Additionally, as referred to in the present disclosure, the term “user input” may include any hand-to-screen interactions (e.g., swipe, pinch, tap, press, etc.), any biometric validation (e.g., retinal scanner, facial recognition, voice recognition/command, etc.), any digital input (e.g., via a track pad, a mouse, a digital pen, or other computer accessory device), etc.), any tactile input (e.g., a shake of the client device), or other suitable types of user inputs.

One conventional tool may include a search bar configured to receive a search query. Upon receipt of the search query, search results including excerpts of the electronic document related to the search query may be displayed in the user interface. To interact with a particular excerpt in the electronic document, conventional tools of user interfaces may require the user to first click or tap on the search result, thereby redirecting the user to the actual location within the electronic document at which the excerpt is located. Often, redirecting the user to the actual location of the excerpt includes automatically changing a rendered search results page to a newly rendered page that includes the excerpt in context of the electronic document itself. Thus, in some conventional applications, the user entirely leaves the search results page. To return to the search results page, a user typically provides a user input to an interactive object (e.g., button) such as the “Back” button.

In other conventional applications, redirecting the user to the actual location of the excerpt includes automatically opening a separate page that includes the excerpt in context of the electronic document itself. The separate page may be in the form of a pop-up window that is given active status and positioned in an overlay manner on top of other pages or windows. The search results page may be partially visible or otherwise substantially not visible. Alternatively, the separate page may be in the form of a new tab, window, or pane that is opened such that the search results page is held intact, but placed entirely behind the newly opened separate page. To return to the search results page from the separate page in any of the former scenarios, the user must typically provide some user input to the user interface to shift positioning of pages and/or alternate between pages.

In the previously discussed conventional applications, user interfaces are overly burdensome and complex, requiring multiple navigational steps and/or positional manipulation of pages to interact with excerpts of the electronic document, e.g., from the search results page. Inefficiencies of such user interfaces are therefore prevalent.

Accordingly, aspects of the present disclosure are directed to modification, annotation, and curation of search results inside a search result window of an improved user interface without leaving the search result window. Navigational steps may be decreased and positional manipulation of pages may be reduced via the improved user interface of the present disclosure. For example, for each search result returned in the search result window of the improved user interface of the present disclosure, a respective excerpt of the electronic document may be displayed along with a corresponding text box immediately adjacent to each excerpt. The text box may be configured to receive text input, e.g., notes, ideas, action items, etc. corresponding to a respective search result, all within the search result window.

Additionally or alternatively, the improved user interface of the present disclosure may be configured to receive, at the search result window, a user input effective to modify a display of one of the one or more search results. For example, the user interface may enable a user to insert a footnote within the excerpt of a search result. Additionally or alternatively, the user interface may enable a user to perform text bolding, text underlining, text italicizing, text highlighting, and font coloring. In some embodiments of the present disclosure, as the user modifies an excerpt of a search result in the search result window, the same excerpt may be correspondingly modified in the electronic document itself. For example, a footnote inserted into the excerpt of a search result in the search result window may be synced and correspondingly inserted in the electronic document itself at the same textual location and with the same footnote text as provided in the footnote inserted within the search result. Thus, in some embodiments of the present disclosure, the improved user interface may enable a user to interact with the electronic document via search results within a search result window without leaving the search result window.

Additionally or alternatively, aspects of the present disclosure may be directed to window panes that open immediately adjacent to each other and maintain visibility of both a former page and a new page. For example, the improved user interface of the present disclosure may provide a group-based chronological display of window panes. In so doing, multiple navigational steps and/or positional manipulation of pages may be reduced to interact with excerpts of the electronic document. Accordingly, efficiencies of the user interface of the present disclosure provide an improvement over conventional user interfaces. Additionally or alternatively, a user may more effectively maintain a train of thought and task awareness due to increased visibility and accessibility to multiple, related windows at any given time in the improved user interface of the present disclosure.

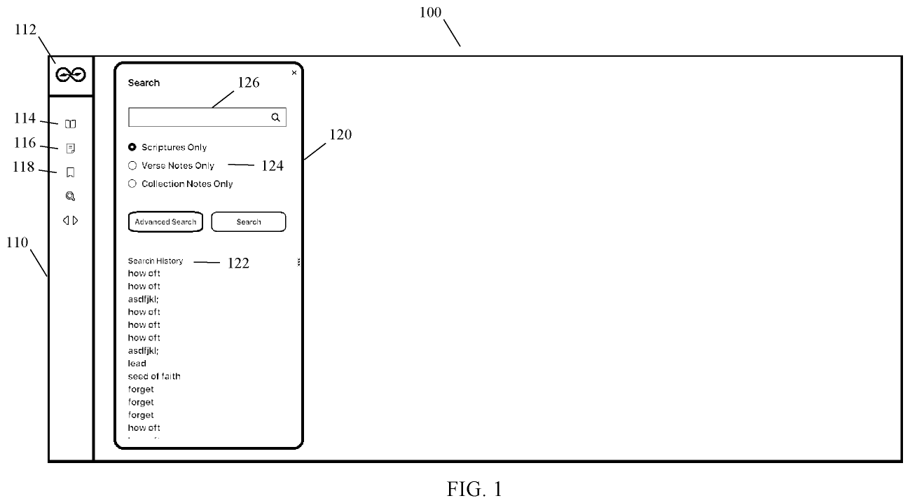

Turning to the figures, FIG. 1 illustrates an example user interface 100 including various tools to interact with an electronic document, the user interface 100 arranged according to one or more embodiments of the present disclosure. As illustrated, the user interface 100 may include a menu bar 110 and a search window 120.

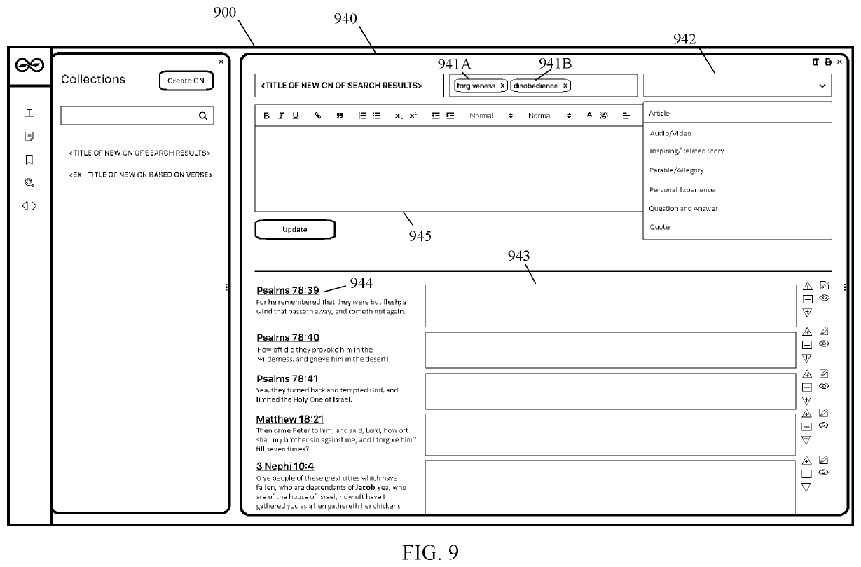

In some embodiments, the menu bar 110 may include multiple features. For example, the menu bar 110 may include interactive objects configured to be selected by a user input. For example, the menu bar 110 may include a dashboard interactive object 112. In some embodiments, in response to receiving input selecting the dashboard interactive object 112, a new window may be opened (e.g., immediately adjacent to the menu bar 110) that may display an account identifier and an activity history. The menu bar 110 may also include a library interactive object 114. In some embodiments, in response to receiving input selecting the library interactive object 114, a new window may be opened (e.g., immediately adjacent to the menu bar 110) that displays various portions of the electronic document, such as books and chapters for selection. The menu bar 110 may also include a collection notes interactive object 116. In some embodiments, in response to receiving input selecting the collection notes interactive object 116, a new window may be opened (e.g., immediately adjacent to the menu bar 110) that displays the collection notes created by the user, for example, at the search results window 120. The collection notes interactive object 116 is discussed in more detail below relative to FIG. 9. The menu bar 110 may also include a tag tree interactive object 118. In some embodiments, in response to receiving input selecting the tag tree interactive object 118, a new window may be opened (e.g., immediately adjacent to the menu bar 110) that displays a listing of tags created by the user, for example at the search result window 120.

The search window 120 may include a search history 122, selectable search content 124, and a search bar 126.

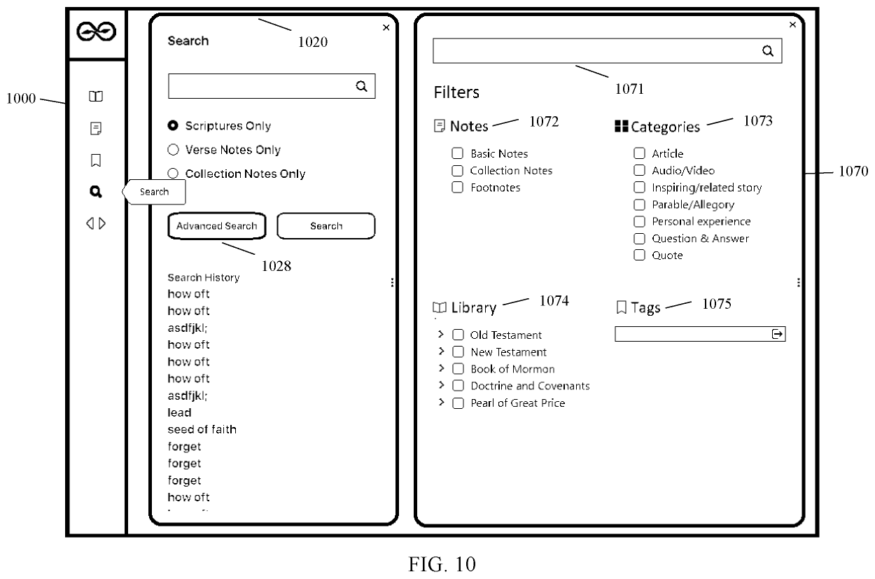

In these or other embodiments, the search history 122 may include a listing of previous search queries entered into the search bar 126 and searched. The search history 122 may be cleared after a specified period of time, e.g., as determined according to default/user settings. Additionally or alternatively, the selectable search content 124 may be configured as a designation of which content is to be searched upon execution of a search query. In one embodiment (as shown), a search may be performed within the original electronic document itself (e.g., scripture text). In other embodiments, a search may be performed within text boxes that include text corresponding to an individual excerpt (e.g., verse notes corresponding to individual verses). In other embodiments, a search may be performed within collection notes that include text corresponding to multiple excerpts (e.g., collection notes corresponding to multiple verses). Additionally or alternatively, a search may be performed within any combination of the original document itself, text boxes, and collection notes. Additional features that correspond to an advanced search may be illustrated in FIG. 10, including Boolean operators and additional filters, searchable content, categories, and tags.

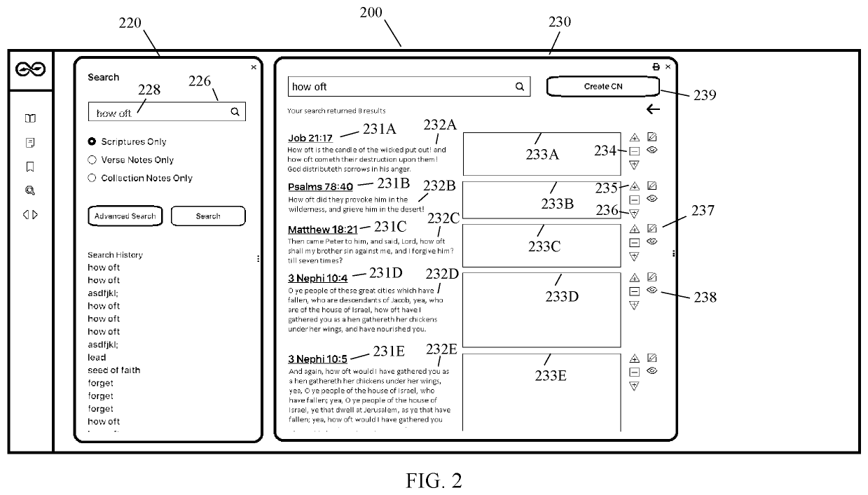

FIG. 2 illustrates the example user interface 200 with an example search query 228, specifically “how oft,” entered into the search bar 226 of the search window 220 that when executed produces example search results. In some embodiments, the example user interface 200 may result from the example user interface 100 of FIG. 1 in response to receiving text input in the search bar 126 and receiving input requesting that a search be performed. In these and other embodiments, the search window 220 and its various components may be similar and/or identical to the search window 120 of FIG. 1.

A search results window 230 may include multiple search results, such as the search result 231A, the search result 231B, the search result 231C, the search result 231D, and the search result 231E (collectively the search results 231). Each of the search results 231 may include an excerpt of the electronic document. For example, the search result 231A may include an excerpt 232A, the search result 231B may include an excerpt 232B, the search result 231C may include an excerpt 232C, the search result 231D may include an excerpt 232D, and/or the search result 231E may include an excerpt 232E. Additionally or alternatively, each of the search results 231 may include a corresponding text box configured to receive text input, e.g., notes, ideas, action items, etc. corresponding to a respective search result. For example, the search result 231A may include a text box 233A, the search result 231B may include a text box 233B, the search result 231C may include a text box 233C, the search result 231D may include a text box 233D, and/or the search result 231E may include a text box 233E (collectively the text boxes 233). The text boxes 233 may be positioned immediately adjacent to the search results 231 within the search result window 230. In some embodiments, text input saved within the text boxes 233 of the search result window 230 may be synced to the electronic document itself such that the corresponding excerpt in the electronic document includes an associated text box with the same text input saved within the text boxes 233 of the search result window 230.

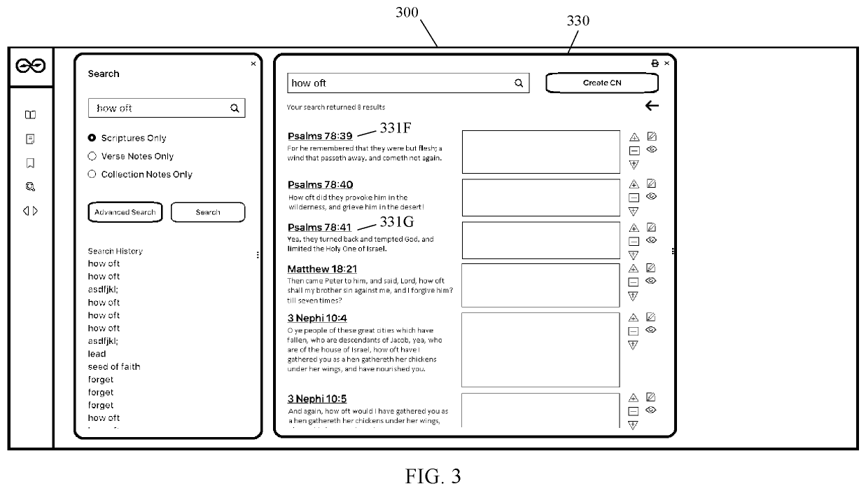

Each of the search results 231 may also include multiple interactive objects of the user interface 200 at which user inputs relating to an individual excerpt may be received (only some of the interactive objects have been labeled for clarity). For example, a minus sign interactive object 234 may be configured to remove a search result. Referencing FIGS. 2 and 3, for example, the search result 231A, “Job 21:17”, may be removed as depicted in FIG. 3 in response to receiving a user input at the minus sign interactive object 234 positioned adjacent to one or both of the individual search result 231A “Job 21:17” and a corresponding text box 233A in FIG. 2.

The search results 231 may also include an up-positive sign interactive object 235 configured to add another excerpt from the electronic document into the search result window 230. The added excerpt may, in some embodiments, immediately precede the respective excerpt of the individual search result 231 within the electronic document. Referencing FIGS. 2 and 3, for example, a search result 331F, “Psalms 78:39”, may be added to the search result window 330 of the user interface 300 of FIG. 3 when the up-positive sign interactive object 235 adjacent to search result 231B, “Psalms 78:40”, receives a user input. In this example, search result 331F of FIG. 3, “Psalms 78:39”, may immediately precede search result 231B of FIG. 2, “Psalms 78:40”, in the electronic document (e.g., the Old Testament).

The search results 231 may also include a down-positive sign interactive object 236 configured to add another excerpt from the electronic document into the search result window 230. The added excerpt may, in some embodiments, immediately succeed the respective excerpt of the individual search result 231 within the electronic document. Referencing FIGS. 2 and 3, for example, a search result 331G, “Psalms 78:41”, may be added to the search result window 330 of FIG. 3 when the down-positive sign interactive object 236 adjacent to search result 231B, “Psalms 78:40”, receives a user input. In this example, search result 331G of FIG. 3, “Psalms 78:41”, may immediately succeed search result 231B of FIG. 2, “Psalms 78:40”, in the electronic document (e.g., the Old Testament).

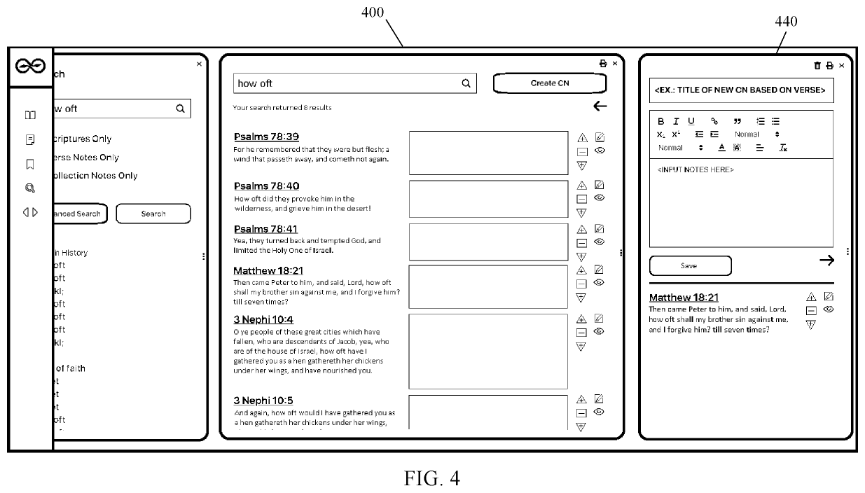

The search results 231 may also include a note interactive object 237 configured to create a note that includes an individual search result 231 and a corresponding text box 233. In these or other embodiments, the note may be a curated collection that includes a single search result 231. Referencing FIGS. 2 and 4, for example, a note interactive object 237 of the search result 231C, “Matthew 18:21”, may be selected via a user input at the user interface 200, creating a new collection 440 at the user interface 400 based on the search result 231C, the verse Matthew 18:21 in the New Testament. Additionally or alternatively, more search results may be added to the note originally associated with the search result 231C, the verse Matthew 18:21 in the New Testament.

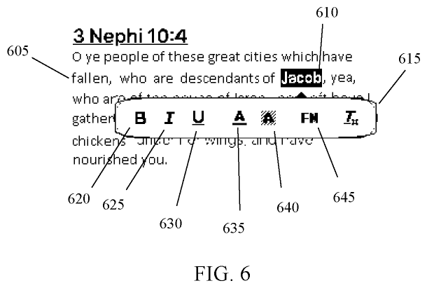

The search results 231 may also include a footnote interactive object 238 configured to, when executed via a user input, display text of a footnote within a search result 231, e.g., as illustrated and described below relative to FIG. 6.

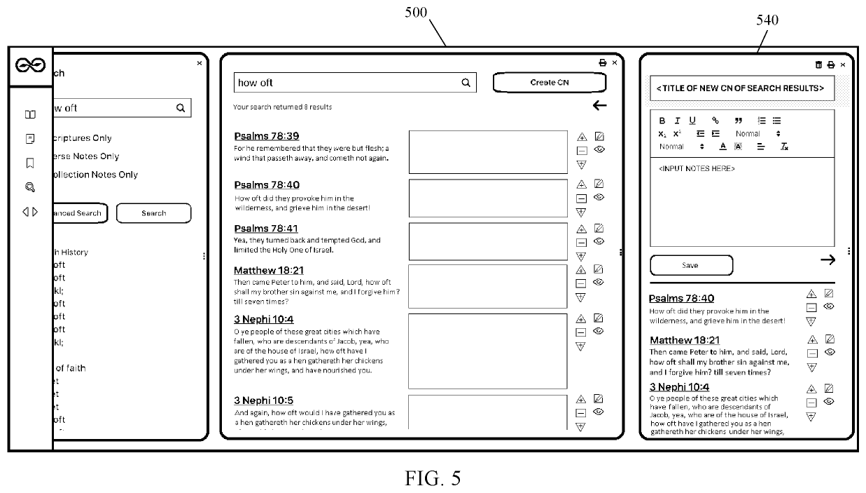

The search results window 230 may also include a Create Collection Notes (“Create CN”) interactive object 239. In some embodiments, the Create CN interactive object 239 may be positioned at one or more of a top position, a bottom position, and a side position of the search result window 230. In these and other embodiments, the example user interface 200 may create a collection including each of the one or more search results 231 and corresponding text boxes 233 in response to receiving input selecting the Create CN interactive object 239 as illustrated in FIG. 5. As illustrated in FIGS. 2 and 5, the Create CN interactive object 239 shown at the top of the search result window 230 may curate a collection of multiple search results 231, e.g., all of the search results 231 into the collection 540 of the user interface 500. In these or other embodiments, the collection 540 of the search results may be given a title. Additionally or alternatively, as illustrated in the user interface 900 of FIG. 9, a collection 940, which may be similar and/or identical to the collection 540 of FIG. 5, may be assigned various tags, such as, for example, a “forgiveness” tag 941A or a “disobedience” tag 941B. In some embodiments, tags may be entered to indicate that the collection 940 relates to a topic of the tags. For example, the “forgiveness” tag 941A and the “disobedience” tag 941B may indicate that the collection 940 relates to “forgiveness” and “disobedience” topics. Additionally or alternatively, the collection 940 may be given an associated category 942 as applicable or desired. For example, the category 942 may include a type for the collection note 940 such as article, audio/video, inspiring/related story, parable/allegory, personal experience, question and answer, quote, etc. Additionally or alternatively, in some embodiments, text boxes 943 may be associated with each excerpt 944 in the collection 940 such that individual notes may be made regarding respective excerpts 944 in the collection. Additionally or alternatively, a master note 945 may be provided that relates to multiple, e.g., all of the excerpts 944 in the collection 940.

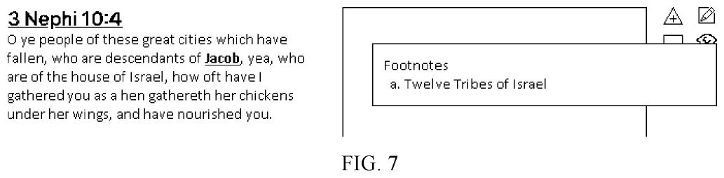

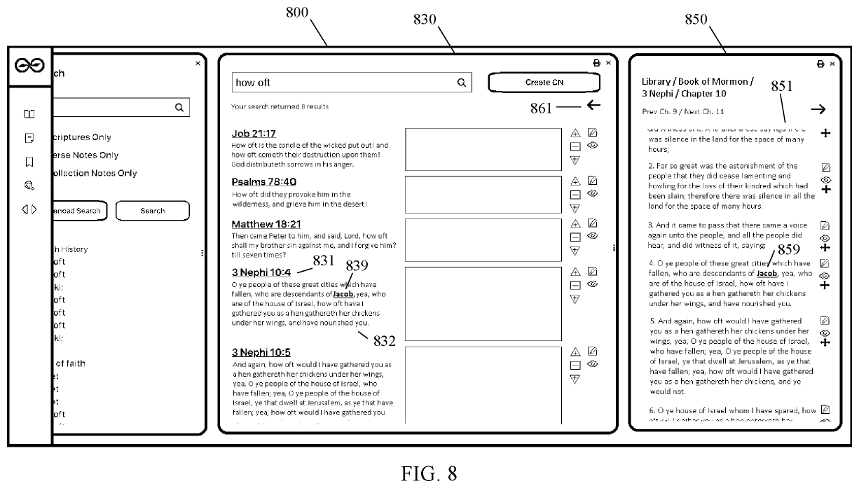

FIGS. 6-8 illustrate additional example functionality of the user interface, e.g., to modify a display of one or more of the search results in the search window. For example, as depicted in FIG. 6, the user interface may allow selection of a portion 610 of one of the excerpts 605, which may initiate an annotation menu 615 including options to bold 620, italicize 625, underline 630, color font 635, highlight 640, and/or footnote 645 the selected portion 610 of the excerpt 605, among other options. FIG. 7 illustrates an example modification of a footnote insertion. Additionally or alternatively, as shown in the user interface 800 of FIG. 8, a modification 839 made to an excerpt such as the excerpt 832 of the search result 831 in the search result window 830 may sync with the electronic document 851 such that the electronic document 851 itself is correspondingly modified in a same manner as performed in the search result window 830 such that the electronic document 851 also includes an identical modification 859. For example, FIG. 8 shows that “Jacob” is footnoted in both the search result 831 of “3 Nephi 10:4” and, when synced, the electronic document 851 itself at the location of 3 Nephi 10:4.

Additionally or alternatively, FIG. 8 illustrates how, in response to receiving a user input at the search result window 830, a next window is displayed immediately adjacent to the search result window 830. For example, in response to a user input at the linked search result 831, “3 Nephi 10:4,” chapter 10 of 3 Nephi is displayed immediately adjacent the search result window 830 as the electronic document window 850 such that both the search result window 850 and chapter 10 of 3 Nephi of the electronic document 851 are simultaneously displayed without obstructing one another. More broadly, in these or other embodiments, a user input received at a current window may initiate a new window immediately adjacent to the current window. In this manner, windows may be displayed as a grouping by chronological event (e.g., left-to-right and less recent to more recent). For example, chronologically after user input selecting the linked search result 831, “3 Nephi 10:4,” another user input may select the linked search result “Matthew 18:21.” The additional user input selecting the linked search result “Matthew 18:21” may initiate a new electronic document window of Matthew chapter 18 immediately adjacent to the search result window 830, thereby positioning the window of Matthew chapter 18 between the search result window 830 and the chronologically-prior electronic document window 850 of chapter 10 of 3 Nephi.

Additionally or alternatively, in some embodiments, various windows of the user interface 800, such as the search results window 830, may include an arrow interactive object 861. In these and other embodiments, the arrow interactive object 861 may be configured to hide from view or minimize the corresponding text box displayed in the search result window 830 adjacent to each search result 831 of the one or more search results.

In some embodiments, each search result of search results may also include a favorite button, which may also be described as a promote button. In these and other embodiments, in response to a user selecting the favorite button associated with a particular search result, the particular search result may appear at the top of the search results. In response to a user selecting the favorite buttons associated with multiple particular search results, the particular search results may appear in a section at the top of the search results. In these and other embodiments, the particular search results may be distinguished from the other search results by, for example, a dividing line between the favorited search results and the other search results, a shading, highlighting, and/or font color distinction between the favorited search results and the other search results, and/or other distinctions. In some embodiments, in response to the user selecting the favorite button associated with a particular search result, the particular search result may be favorited across different search queries. For example, a search result may appear at the top for the particular search query during which the result was favorited and for other search queries. Alternatively or additionally, in some embodiments, the selection of a particular search result as a favorite search result may be associated with the particular search query. For example, the search result may appear at the top for the particular search query during which the result was favorited but not for other search queries.

In some embodiments, a user may add an additional item to the search results. For example, the user may desire that an additional item, such as an additional document and/or an additional citation to a document also appear in the search results. In these and other embodiments, the additional item may be unrelated to the search results that are listed. For example, the user may desire to add as an additional item a citation to a source that was not searched. For example, the search query may have been performed over a particular book or set of books. The user may desire to add as a search result an additional citation to a treatise. The user may select a button to add an additional citation and may enter the citation into a text box.

In some embodiments, a user may combine search results from two or more searches. For example, the user may perform a first search using a first search query to generate a first set of search results. The user may also perform a second search using a second search query to generate a second set of search results. The user may then combine the first set of search results and the second set of search results. For example, the user may combine the search results into a collection. In some embodiments, the user may associate the first set of search results and the second set of search results with the first search query and/or the second search query. For example, a bulk copy operation may be performed in which each search result of the second set of search results is copied into the first set of search results. In these and other embodiments, associating the first set of search results and the second set of search results with the first search query may cause the first set of search results and the second set of search results to be displayed in response to the user performing a search using the first search query.

In some embodiments, a collection of search results may be shared. For example, the collection may be shared on one or more social media sites, such as, for example, Instagram™ Facebook™, Twitter™, and other social media sites. In these and other embodiments, the user interface may generate one or more open graph tags associated with the collection such as a title of the collection, an image of the collection, a description of the collection, and/or other open graph tags. For example, in some embodiments, the user interface may designate the search query as the open graph title, og:title. In these and other embodiments, a picture of the search results and/or snippets of the search results may be designated as the open graph image, og:image. In these and other embodiments, text associated with one or more search results and/or text associated with the search query may be designated as the open graph description, og:description. In some embodiments, the user interface may designate elements of the search results as other open graph tags.

In some embodiments, a collection note may be shared, similar to the collection of search results discussed above. In these and other embodiments, the user interface may generate one or more open graph tags associated with the collection such as a title of the collection note, an image of the collection note, a description of the collection note, and/or other open graph tags. In these and other embodiments, a user may designate the og:title through a text box. Alternatively or additionally, in some embodiments, the og:title may correspond to a search query associated with the collection note. In these and other embodiments, the user may select a picture as the og:image. In some embodiments, the og:title may appear in the foreground of the og:image. In some embodiments, the user may also enter an og:description. In these and other embodiments, the user may enter part of the search string as the og:description. Alternatively, the user may enter any text as the og:description.

FIG. 10 illustrates additional features that correspond to an advanced search. In some embodiments, in response to receiving input selecting an advanced search interactive object 1028 in a search window 1020, an advanced search window 1070 may be presented in the user interface 1000. In these and other embodiments, the advanced search window 1070 may include a search bar 1071 that may receive text associated with a search query. The advanced search window may also include various filters such as a notes filter 1072, a categories filter 1073, a library filter 1074, and a tags filter 1075.

The notes filter 1072 may allow a user to select whether to search notes together with various library items. For example, a search may be performed on basic notes, which may include text entered into a text box associated with an excerpt, such as any of the text boxes 233 of FIG. 2. Alternatively or additionally, a search may be performed on collection notes, which may include text entered into a collection note such as the master note 945 of FIG. 9. Alternatively or additionally, a search may be performed on footnotes, which may include text entered as a footnote such as the footnote depicted in FIG. 7. The categories filter 1073 may allow a user to select to search particular categories of electronic documents. For example, as discussed above relative to FIG. 9, a collection note may be assigned a particular category. Using the categories filter 1073, particular categories of collection notes may be searched. The library filter 1074 may allow a user to select particular electronic documents to be searched. The tags filter 1075 may allow a user to enter one or more tags to search electronic documents by their associated tags.

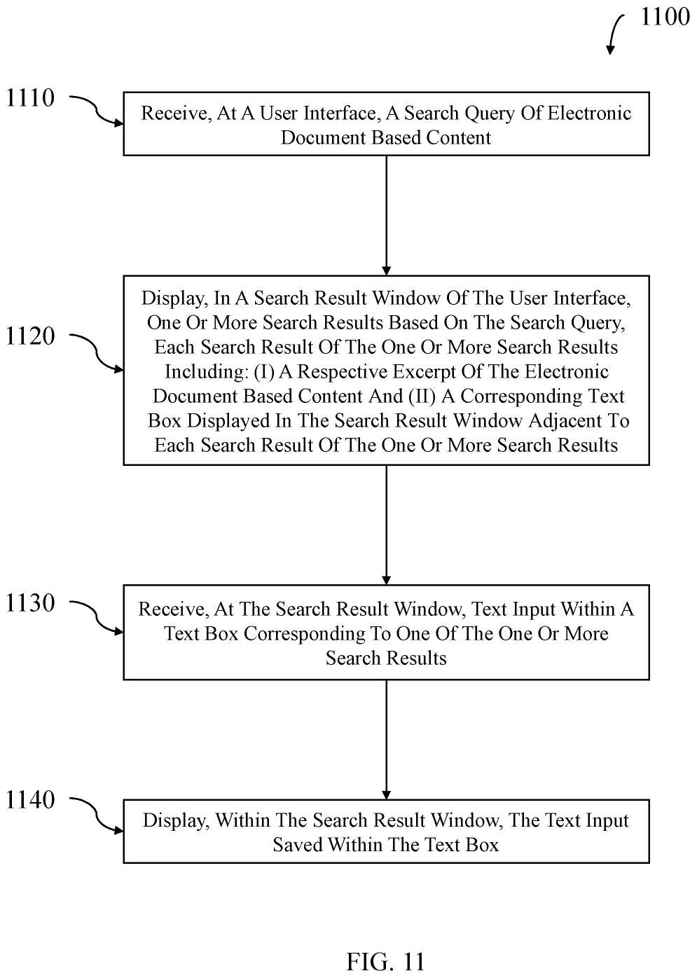

FIG. 11 is a flowchart of an example method of automated searching and identification of software patches. The method 1100 may be arranged in accordance with at least one embodiment described in the present disclosure. The method 1100 may be performed, in whole or in part, in some embodiments, by a system and/or environment, such as any of the user interfaces discussed above. In these and other embodiments, the method 1100 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 1100 may begin at block 1110, where a search query of electronic document based content may be received at a user interface. In block 1120, one or more search results may be displayed in a search result window of the user interface based on the search query. Each search result of the one or more search results may include (i) a respective excerpt of the electronic document based content and (ii) a corresponding text box displayed in the search result window adjacent to each search result of the one or more search results. In some embodiments, the search result window may be displayed immediately adjacent a search window. In some embodiments, in response to receiving a user input at the search result window, displaying a next window immediately adjacent to the search result window.

In block 1130, text input may be received at the search result window within a box corresponding to one of the one or more search results. In block 1140, the text input saved with the text box may be displayed within the search result window.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. In some embodiments, the method 1100 may include additional blocks or fewer blocks. For example, in some embodiments, the method 1100 may not include the block 1130 and/or the block 1140. Alternatively or additionally, in some embodiments, the method 1100 may include receiving, at the search result window, a user input via an interactive object positioned adjacent to one or both of an individual search result and a corresponding text box that removes both the individual search result and the corresponding text box from the search result window.

Alternatively or additionally, in some embodiments, the method 1100 may include receiving, at the search result window, a user input via an interactive object positioned adjacent to one or both of an individual search result and a corresponding text box, the interactive object when executed adding another excerpt from the electronic document based content to the search result window. In some embodiments, the added excerpt may be an excerpt that immediately precedes or immediately succeeds the respective excerpt of the individual search result within the electronic document based content.

Alternatively or additionally, in some embodiments, the method 1100 may include receiving, at the search result window, a user input effective to modify a display of one of the one or more search results. In some embodiments, the modification to the display of the one or more search results may correspondingly modify the respective excerpt in the electronic document based content. In some embodiments, the modification to the display of the one or more search results may include one or more of: a footnote insertion, text bolding, text underlining, text italicizing, text highlighting, and font coloring.

Alternatively or additionally, in some embodiments, the method 1100 may include curating one or more of the one or more search results into a collection. In some embodiments, the method 1100 may include receiving, at the search result window, a user input via an interactive object positioned adjacent to one or both of an individual search result and a corresponding text box that creates the collection including the individual search result and the corresponding text box. In some embodiments, the method 1100 may include receiving, at the search result window, a user input via an interactive object positioned at one or more of a top position, a bottom position, and a side position of the search result window that creates the collection including each of the one or more search results and corresponding text boxes. Alternatively or additionally, in some embodiments, the method 1100 may include receiving, at the user interface, a second search query of electronic document based content. In these and other embodiments, the method 1100 may include displaying, in a second search result window of the user interface, one or more second search results based on the second search query. Each second search result of the one or more second search results may include a respective excerpt of the electronic document based content and a corresponding text box displayed in the second search result window adjacent to each second search result of the one or more second search results. In these and other embodiments, the method 1100 may include copying one or more of the one or more second search results into the collection.

Alternatively or additionally, in some embodiments, the method 1100 may include generating one or more open graph tags associated with the collection. Alternatively or additionally, in some embodiments, the method 1100 may include displaying, at a collection notes window of the user interface, the one or more search results associated with the collection. In these and other embodiments, the method 1100 may include receiving, at the collections note window, input designating a particular search result as a promoted search result. In these and other embodiments, the method 1100 may include displaying, within the collection notes window, the promoted search result above other search results associated with the collection.

One or more aspects of the present disclosure may be achieved via an example method, such as one or more of the methods disclosed in the claims of the present disclosure. In these or other embodiments, an example method of the present disclosure may be performed as discrete blocks, and, in some embodiments, various blocks may be divided into additional blocks, combined into fewer blocks, or eliminated, depending on the desired implementation. In some embodiments, an example method of the present disclosure may include one or more steps implementing a memory component and at least one processor, which are configured to perform at least one operation as described in this disclosure, among other operations. In some embodiments, a software system may include computer-readable instructions that are configured to be executed by the memory component and/or the at least one processor to perform operations described in this disclosure.

Generally, the processor may include any suitable special-purpose or general-purpose computer, computing entity, or processing device including various computer hardware or software modules and may be configured to execute instructions stored on any applicable computer-readable storage media. For example, the processor may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

It is understood that the processor may include any number of processors distributed across any number of networks or physical locations that are configured to perform individually or collectively any number of operations described herein. In some embodiments, the processor may interpret and/or execute program instructions and/or processing data stored in the memory. By interpreting and/or executing program instructions and/or process data stored in the memory, the software system may perform operations, such as the operations performed by the memory and/or the at least one processor.

The memory may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. In these and other embodiments, the term “non-transitory” as used herein should be construed to exclude only those types of transitory media that were found to fall outside the scope of patentable subject matter in the Federal Circuit decision of In re Nuijten, 500 F.3d 1346 (Fed. Cir. 2007). In some embodiments, computer-executable instructions may include, for example, instructions and data configured to cause the processor to perform a certain operation or group of operations as described in the present disclosure.

One skilled in the art will appreciate that, for these processes, operations, and methods of the present disclosure, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner. Additionally, the term “about” or “approximately” should be interpreted to mean a value within 10% of actual value.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving, at a user interface, a search query of electronic document based content;
displaying, in a search result window of the user interface, one or more search results based on the search query, each search result of the one or more search results including: (i) a respective excerpt of the electronic document based content and (ii) a corresponding text box displayed in the search result window adjacent to each search result of the one or more search results;
receiving, at the search result window, text input within a text box corresponding to one of the one or more search results; and
displaying, within the search result window, the text input saved within the text box.

2. The method of claim 1, further comprising:
receiving, at the search result window, a user input via an interactive object positioned adjacent to one or both of an individual search result and a corresponding text box that removes both the individual search result and the corresponding text box from the search result window.

3. The method of claim 1, further comprising:
receiving, at the search result window, a user input via an interactive object positioned adjacent to one or both of an individual search result and a corresponding text box, the interactive object when executed adding another excerpt from the electronic document based content to the search result window.

4. The method of claim 1, wherein the search result window is displayed immediately adjacent a search window.

5. The method of claim 4, further comprising:
in response to receiving a user input at the search result window, displaying a next window immediately adjacent to the search result window.

6. A non-transitory computer-readable medium having encoded therein programming code executable by a processor to perform operations comprising:
receiving, at a user interface, a search query of electronic document based content;
displaying, in a search result window of the user interface, one or more search results based on the search query, each search result of the one or more search results including: (i) a respective excerpt of the electronic document based content and (ii) a corresponding text box displayed in the search result window adjacent to each search result of the one or more search results; and
receiving, at the search result window, a user input effective to modify a display of one of the one or more search results.

7. The non-transitory computer-readable medium of claim 6, wherein the modification to the display of the one or more search results correspondingly modifies the respective excerpt in the electronic document based content.

8. The non-transitory computer-readable medium of claim 6, wherein the modification to the display of the one or more search results includes one or more of: a footnote insertion, text bolding, text underlining, text italicizing, text highlighting, and font coloring.

9. The non-transitory computer-readable medium of claim 6, wherein the operations further comprise:
receiving, at the search result window, text input within a text box corresponding to one of the one or more search results; and
displaying, within the search result window, the text input saved within the text box.

10. The non-transitory computer-readable medium of claim 6, wherein the operations further comprise:
receiving, at the search result window, a user input via an interactive object positioned adjacent to one or both of an individual search result and a corresponding text box that removes both the individual search result and the corresponding text box from the search result window.

11. The non-transitory computer-readable medium of claim 6, wherein the operations further comprise:
receiving, at the search result window, a user input via an interactive object positioned adjacent to one or both of an individual search result and a corresponding text box, the interactive object when executed adding another excerpt from the electronic document based content to the search result window.

12. The non-transitory computer-readable medium of claim 11, wherein the added excerpt is an excerpt that immediately precedes or immediately succeeds the respective excerpt of the individual search result within the electronic document based content.

13. The non-transitory computer-readable medium of claim 6, wherein one or more of the one or more search results may be curated into a collection.

14. The non-transitory computer-readable medium of claim 13, wherein the operations further comprise:
receiving, at the search result window, a user input via an interactive object positioned adjacent to one or both of an individual search result and a corresponding text box that creates the collection including the individual search result and the corresponding text box.

15. The non-transitory computer-readable medium of claim 13, wherein the operations further comprise:
receiving, at the search result window, a user input via an interactive object positioned at one or more of a top position, a bottom position, and a side position of the search result window that creates the collection including each of the one or more search results and corresponding text boxes.

16. The non-transitory computer-readable medium of claim 6, wherein the operations further comprise:
receiving, at the search result window, a user input effective to hide from view the corresponding text box displayed in the search result window adjacent to each search result of the one or more search results.

17. A system comprising:
one or more processors; and
one or more computer-readable media configured to store instructions that in response to being executed by the one or more processors cause the system to perform operations, the operations comprising:
receiving, at a user interface, a search query of electronic document based content;
receiving, at a user interface, a search query of electronic document based content;
displaying, in a search result window of the user interface, one or more search results based on the search query, each search result of the one or more search results including: (i) a respective excerpt of the electronic document based content and (ii) a corresponding text box displayed in the search result window adjacent to each search result of the one or more search results; and
curating one or more of the one or more search results into a collection.

18. The system of claim 17, wherein the operations further comprise:
receiving, at the user interface, a second search query of electronic document based content;
displaying, in a second search result window of the user interface, one or more second search results based on the second search query, each second search result of the one or more second search results including: (i) a respective excerpt of the electronic document based content and (ii) a corresponding text box displayed in the second search result window adjacent to each second search result of the one or more second search results; and
copying one or more of the one or more second search results into the collection.

19. The system of claim 17, wherein the operations further comprise:
generating one or more open graph tags associated with the collection.

20. The system of claim 17, wherein the operations further comprise:
displaying, at a collection notes window of the user interface, the one or more search results associated with the collection;
receiving, at the collections note window, input designating a particular search result as a promoted or favorited search result; and
displaying, within the collection notes window, the promoted or favorited search result above other search results associated with the collection.
